(19) United States
(12) Patent Application Publication
(10) Pub. No.: US 2008/0031458 A1
(43) Pub. Date: Feb. 7, 2008

(54) System, methods, and apparatus for simplified encryption

(76) Inventor: Robert Raja, Chetpet (IN)

Correspondence Address: DAVID P. LENTINI, 53 Clark Road, North Berwick, ME, 03906-6310, US

(21) Appl. No.: 11/360,453

(22) Filed: Feb. 23, 2006

(30) Foreign Application Priority Data
Feb. 23, 2005 (IN) 152/CHE/2005
Feb. 23, 2005 (IN) 153/CHE/2005

(51) Int. Cl. H04L 9/00

(52) U.S. Cl. 380/279

(57) ABSTRACT

Systems, methods, and apparatus for providing encryption presented. In some examples, a system for secure data transmission is provided that includes an encryption key server that is configured to provide a encryption key in response to a request from a client computer; the key server being further configured to provide an identifier that is associated uniquely with the encryption key.

### 1 CLAIMS TO FOREIGN PRIORITY

This application claims priority under 35 U.S.C. § 119(a) form Indian Patent Application Serial No.: 152/CHE/2005 and Indian Patent Application Serial No.: No.: 153/CHE/2005, both filed 23 Feb. 2005. The disclosures of these two applications are incorporated herein by reference in their entireties and for all purposes.

### 2 COPYRIGHT NOTICE

A portion of the disclosure of this patent document contains material that is subject to copyright protection. The copyright owner has no objection to anyone reproducing the patent disclosure as it appears in the Patent and Trademark Office patent files or records. However, the copyright owner strictly reserves all other copyrights.

### 3 BACKGROUND OF THE INVENTION

3.1 Field of the Invention

The present invention relates to providing securely encrypted electronic data and signals comprising such data. Thus, the invention has applications in the fields of computer science, computer networking, telecommunications, and electronics.

3.2 The Related Art

The increasing need for sharing information has led to a marked surge in the use of computer networks inside offices and homes as well as among locations across the globe. Much of the information is confidential in nature, including trade secrets, sensitive business and financial information, and even personal secrets. Even within an office or home network or stand-alone computer there is a need to control access to such sensitive information. Increasingly, sensitive information in carried on laptops by traveling businesspersons, government officials, and individuals. Thus, the demand of users for methods and systems to protect their information from unauthorized access has always been a priority for computer engineers.

Cryptographic systems are often used to protect sensitive electronic information. These systems are classified generally into symmetric- and asymmetric key encryption systems. Symmetric key encryption algorithms typically make use of a single key to perform the operations of encryption and decryption. By virtue of the nature of symmetric key algorithms, they are much faster than asymmetric key algorithms and hence preferred in close to real time environments that require cryptography. Also, the use of symmetric systems demands Herculean efforts in secure key distribution and maintenance.

Asymmetric encryption cryptographic systems use two keys: one for encryption and the other for decryption. Either key can encrypt or decrypt a message; thus, the two keys are complementary. The key used for decryption is usually kept confidential and is called the private key. The other key, which is used for encryption, is called the public key and is made public knowledge. This system of encryption is however generally preferred for secure key distribution. Also, the public key maintenance and distribution is entrusted to a third party thus relieving the user of the system the burden of key management. Nevertheless, the infrastructure required to make the system complete, which includes digital certificates to identify the users, certification authorities, registration authorities, digital signatures, certification revocation lists, and online certification status protocol among others is complicated and esoteric to most users.

Thus both types of public key cryptographic systems, although powerful, suffer some drawbacks to widespread user adoption. The present method addresses this and other needs.

### 4 SUMMARY OF THE INVENTION

The present invention provides systems, methods, and apparatus that allow powerful encryption with greatly reduced user complexity compared to current methodologies. The systems, methods, and apparatus described herein can be used in conjunction with a wide variety of data types, including without limitation e-mail, VOIP, a data file, image data, or sound data, and devices such as desktop and laptop computer, cell phone, portable digital assistants, portable media players, game consoles, and the like, as will become apparent hereinbelow.

In a first aspect, the present invention provides a system for secure data transmission. In one embodiment, the system of the invention comprises a encryption key server that is configured to provide a encryption key in response to a request from a client computer. The encryption key server is further configured to provide an identifier that is associated uniquely with the encryption key. In a more specific embodiment, the encryption key is the public key of a key pair consisting of a public key and a private key. In a still more specific embodiment, the identifier is associated uniquely with the public key. The identifiers can be stored in a database and associated with other user properties, such as e-mail addresses.

In a second aspect, the present invention provides a method for encrypting data. In one embodiment, the method provided by the invention comprises sending a request for an encryption key and unique identifier associated with the encryption to a encryption key server. The encryption key server is configured to provide the encryption key in response to the request, and the encryption key server is further configured to provide an identifier that is associated uniquely with the encryption key. In some embodiments, the method of the invention further includes comparing the unique identifier against a database of identifiers. In still other embodiments, the method of the invention further includes associating said identifier with a public key of a public-private encryption key pair.

These and other aspects and advantages will become apparent when the Description below is read in conjunction with the accompanying Drawings.

### 5 BRIEF DESCRIPTION OF THE DRAWINGS

FIG. 1 illustrates a computer and telecommunications network including a encryption key server in accordance with the present invention.

FIG. 2 is a flowchart illustrating a method for encrypting data in accordance with one embodiment of the invention.

FIG. 3 is a flowchart illustrating a registration process in accordance with one embodiment of the invention.

FIG. 4 is a flowchart illustrating a process for creating encryption keys in accordance with one embodiment of the invention.

FIGS. 5A and 5B illustrate data structures in accordance with one embodiment of the invention. FIG. 5A illustrates a data structure for requesting a recipient's private key according to one embodiment of the present invention. FIG. 5B illustrates a data structure for the response to the request for a recipient's private key according to one embodiment of the present invention.

### 6 DESCRIPTION OF SOME EMBODIMENTS OF THE INVENTION

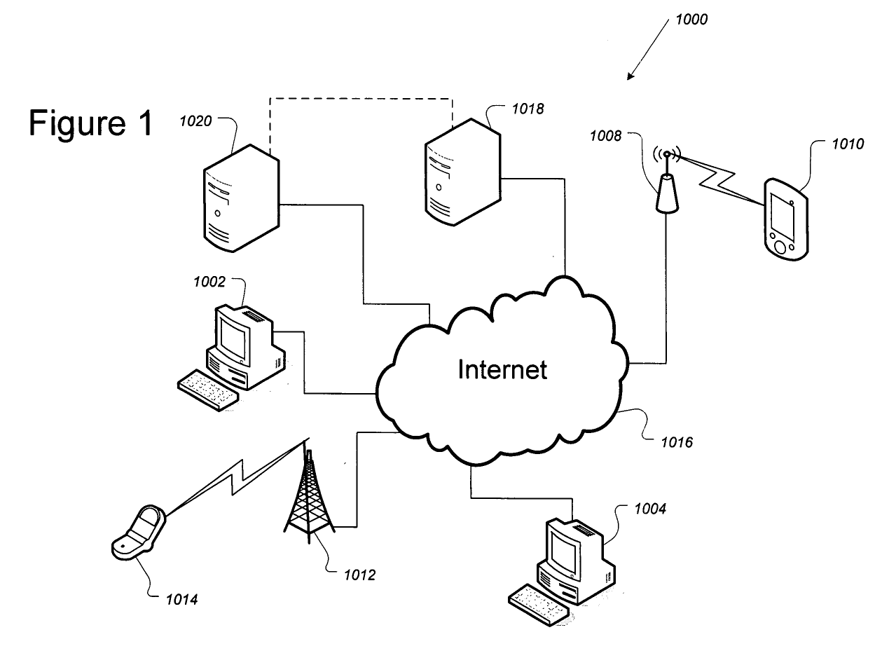

In a first aspect, an example of which is illustrated in FIG. 1, the present invention provides a system (1000) including a first computer (1002) that communicates with one or more remote computer(s) (1006), wireless devices, for example through a base station (1008) communicating with a personal digital assistant (1010), or by an antenna (1012) to a remote cell phone (1014), through the Internet (1016) or other computer network (not shown). Still other devices that can participate in such communication will be apparent to those having ordinary skill in the art. Each of the foregoing devices is also in communication with a encryption key server of the invention (1018), the configuration and operation of which will be described hereinbelow, as well as a Web server (1020), which may be optionally connected with the encryption key server (1018) by a separate connection. (Although only one encryption key server and one Web server are shown in FIG. 1, any number of encryption key servers or Web servers (or both) can be used as described herein.) The nature of the data exchanged between these devices will not be a limitation on the invention as will become apparent below. Nevertheless, illustrative examples of the types of communication between devices in accordance with the present invention include, without limitation: electronic mail, operational code (including Active-X files, Java files, and dynamically linked libraries), video files (e.g., JPEG-, MPEG-, MOV-formatted files), sound files (e.g., WAV-formatted files), data files (including word processor, spreadsheet, and presentation documents), image files, and voice (e.g., VOIP). In addition, the communication can be done using shared folders, such as available in peer-to-peer data sharing systems, by burst- or continuous transmission (e.g., file transfer (such as FTP), video or audio streaming, or VOIP), or single-shot transmission (e.g., e-mail). Examples of using the present invention to transmit and receive secure e-mail are described in co-pending U.S. patent application Ser. No. ______ (Attorney Docket No. KYGLU001) filed on even date herewith and which is incorporated herein by reference in its entirety and for all purposes. The hardware and communication types just described are of standard design and construction and their operation will be understood by those having ordinary skill in the art.

In a more particular embodiment, the encryption key server (1018) is a secure public encryption key server. In one specific exemplary embodiment, the encryption is accomplished using an RSA public key encryption algorithm that makes use of keys of the order of 1024-, 2048-, or 4096 bits (or greater). The Public Key Cryptographic Standards #1 (PKCS #1) contains the specifications for the implementation of the public key cryptography based on the RSA algorithm. In some more specific embodiments, a 1024-bit RSA key is used, which offers a reasonably strong balance of security vs. computing powers for most business organizations, governments, schools, and other institutions. In an alternative example, some embodiments of the present invention use the AES (Advanced Encryption Standard) to provide encrypted data. As will be familiar to those having ordinary skill in the art, AES has been selected by NIST (National Institute of Standards and Technology) as a Federal Information Processing Standard (FIP S-197). The AES algorithm uses key sizes of 128-, 192-, or 256 bits. In some more specific embodiments, a 256-bit AES key is used, which offers a reasonably strong balance of security vs. computing powers for most business organizations, governments, schools, and other institutions.

In one exemplary embodiment, each entity engaging in secure communication as described above with respect to FIG. 1 obtains a Numerical Id. that represents a public key (and optionally other security information), which is stored at a location that is accessible to the user when the user desires to encrypt information to be sent over the Internet or other network as illustrated in FIG. 1. For example, the public key can be stored on the user's computer or on a data storage location that is accessible to the user's computer, such as a remote drive or a portable data storage device. According to the instant particular exemplary embodiment, when the Numerical Id is created, public- and private keys are created for the user (e.g., an RSA 1024-bit key). The public key is registered with a secure public key distribution system such as represented by encryption key server 1016. (According to this embodiment, the private key is not registered with the server and does leave the possession of the owners, i.e., none of the components in the public key server system ever come into contact with user private keys.) In addition, each user must have installed a software module for encryption and decryption as described herein that also includes the Numerical Ids. of the correspondents. The Numerical Id. can be of any length and form suitable for securely identifying a user of the invention; and, more particularly, is of a length and form not being inconvenient for the user to remember. In some still more specific embodiments, the Numerical Id. is a ten-digit number. These operations can be implemented using methods known to those having ordinary skill in the art.

In operation, the data being transmitted securely is encrypted initially using a session key (e.g., a 256-bit AES session key), which is generated at random. (The size and type of session key, and method used to generate the key, can be any suitable for the desired degree of security versus computing power overhead.) The session key is transmitted securely to the persons in the network who are authorized to access the data being transmitted. For this purpose, the session key can be further encrypted using the public keys of the authorized persons, e.g., by making use of the RSA algorithm in the process. The encrypted keys are embedded into an encrypted message header, thus making them available during decryption. These operations can be implemented using methods known to those having ordinary skill in the art.

In a more particular exemplary embodiment of the invention, the software module referenced above obtains the Numerical Ids of all entities authorized to access the unencrypted data. It then contacts a encryption key server requesting the corresponding public keys for the Numerical Ids sent along with the request. On receipt of the response from the encryption key server, the module proceeds to encrypt the session key with the public keys and embeds them into the header of the encrypted message. The header will also contain other information pertaining to the invention, basically used to identify the message as having been encrypted under the invention and also for ease of decryption.

Next, this session key is transferred securely to the entities who are authorized to access the unencrypted data. For this purpose, the session key is further encrypted using the public keys of the authorized persons, e.g., making use of the RSA algorithm in the process. (Again, however, the size and type of session key, and method used to generate the key, can be any suitable for the desired degree of security versus computing power overhead.) The encrypted keys are embedded into the encrypted message header, thus making them available during decryption.

In one embodiment, the message header includes some or all of the following information:
An identifier to signify that the content has been encrypted using the system of the invention,
A flag to indicate if the content is encrypted, sender-authenticated or both,
The Numerical Ids of all the recipients,
The length of the encrypted content,
The encrypted key (once for each of the recipients),
The Numerical Id of the sender, and
The authentication information computed with the sender's private key.

In some embodiments, the encrypted key is an AES key. In other embodiments, the authentication includes a hash or other indication of integrity such as an SHA-1 digest.

Additional blocks may be appended to the header as well. In some embodiments, one or more of the following blocks is provided in the header.

Field Size Description:

| Field | Size | Description |
|---|---|---|
| Block Identifier | 8 bytes | An indicator to show |
| | | that this is a block |
| | | under the invention. |
| | | Typical |
| | | value = 33560000 |
| Major Version | 1 byte | To accommodate |
| | | enhancements |
| Minor Version | 1 byte | To accommodate |
| | | enhancements |
| File Type | 2 bytes | Flag to show if the |
| | | encrypted content is |
| | | in binary form or in |
| | | base-64 encoding. Also |
| | | to show if the content |
| | | is encrypted or |
| | | authenticated or both |
| | | and also to show the |
| | | encryption algorithm |
| | | if encrypted. |
| Header Length | 4 bytes | The length of the |
| | | header block including |
| | | the repeated recipient |
| | | and authenticator |
| | | information. |
| Content Length | 8 bytes | The length of the |
| | | encrypted/ |
| | | authenticated content |
| Number of Recipients | 2 bytes | The number of persons |
| | | who can decrypt the |
| | | encrypted content |
| Number of | 2 bytes | The number of persons |
| Authenticators | | who have authenticated |
| | | the content. |
| Initialization Vector | 32 bytes | Initial value for |
| | | encryption in the |
| | | symmetric algorithm |

Recipient Information:

| Field | Size | Description |
|---|---|---|
| Numeric ID | 16 bytes | Numeric ID of the |
| | | recipient |
| Encrypted Session Key | 240 bytes | The session key |
| | | encrypted with the |
| | | public key of the |
| | | recipient |

Authenticator Information (Repeated Once for Each Number of Authentications):

| Field | Size | Description |
|---|---|---|
| Numeric ID | 16 bytes | Numeric ID of the |
| | | authenticator |
| Signature | 240 bytes | Digest of the |
| | | authenticated content |
| | | encrypted with the |
| | | private key of the |
| | | authenticator |

In addition to the header exemplified above, in some embodiments the invention also includes a more comprehensive header to the encrypted message to indicate to the reader that this is a message encrypted using the methods and systems of the present invention. This header will have words to the effect “This is an encrypted message under the invention” and may also include a brief description of how to decrypt the said message. A typical encrypted text header will thus look similar to the following:

Keygloo Encrypted Message !!
Use the Decrypt button in the Keygloo toolbar
(3356330510 91 03 48000 00284 0100y brg 4Illn nutb6qa DV/Jv
w==00000 00000000 00000000 00000000 00000000
00033050 00102000 000GT/pH y0 5CzOqS NC6N1Sa H m/Pf9r x kcME
Jq8 OXBSVNIB Yn NxOUj1w iS vRcJUmI UW/ScZ LAjWm zk7 SGO5
VHpq0N0 Iw k5Yy FGhC7NM +W96 i2 4Kqy/ ax Lqo1E GJP0ucHn
CGWX 6dQmNx+ X DIst4 cIin 2JB fT2tRZZ oly/d3GC
G2AkqM8= 00000000 00000000 00000000 00000000 00000000

As noted above with respect to FIG. 1, senders and receivers of secure messages using the present invention have hardware and software that are appropriate to fulfill the roles of encrypting and decrypting data in accordance with the invention as illustrated herein. In one embodiment, the software module (or modules) that comprise the client side software are made available for download from a server, such as a Web server, either through the Hyper Text Transfer Protocol (HTTP) or File Transfer Protocol (FTP). Alternative forms of distribution can be used as well. The Web server can also perform the function of obtaining personal details including the email id of the user who downloads the software for the purpose of sending him a software activation password. The Web server forwards the email id to the public encryption key server (1018) for registration. These operations can be implemented using methods known to those having ordinary skill in the art.

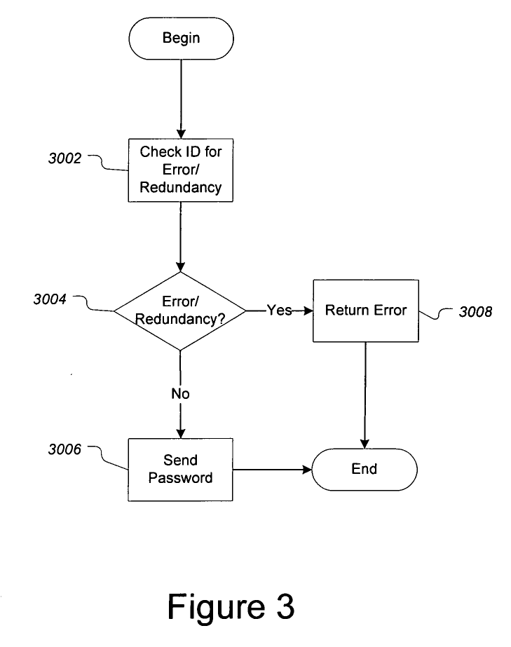

One example of a registration process is illustrated in FIG. 3. There, an ID, (an e-mail id) is obtained and checked for any error or redundancy (or both) (3002) from a first database of previous users who have already registered their public keys with the system. In another embodiment, in the absence of an error, such as redundancy, the ID is checked with a second database that contains the IDs of users who have registered their IDs but not their public keys. The entries of this second database can have an expiration period (e.g., an expiration period of 2 days) after which the redundancy does not matter. If there is an absence of redundancy (3004) here too, the ID is added to the first database and an activation password, e.g., a random string, is generated and returned by the public encryption key server (3006). Otherwise an error is returned (3008). These operations can be implemented using methods known to those having ordinary skill in the art.

In one embodiment, the above-mentioned client software includes a first module having suitable programming code and scripts that aid in the generation of a key pair using a suitable public key cryptographic algorithm. In some embodiments, the software includes a suitable module for initiating and carrying through the registration of the key pair generated by first module. Also, in one embodiment, the second module is responsible for obtaining a Numeric Id. from the secure public encryption key server (1018), which is also the Numeric Id. associated with the public key of the key pair. In another embodiment, a third module assumes the role of a client whenever the public encryption key server (1018) is tasked to provide a public key associated with the Numeric Id. In some embodiments of the invention, such requisition is required. These operations can be implemented using methods known to those having ordinary skill in the art.

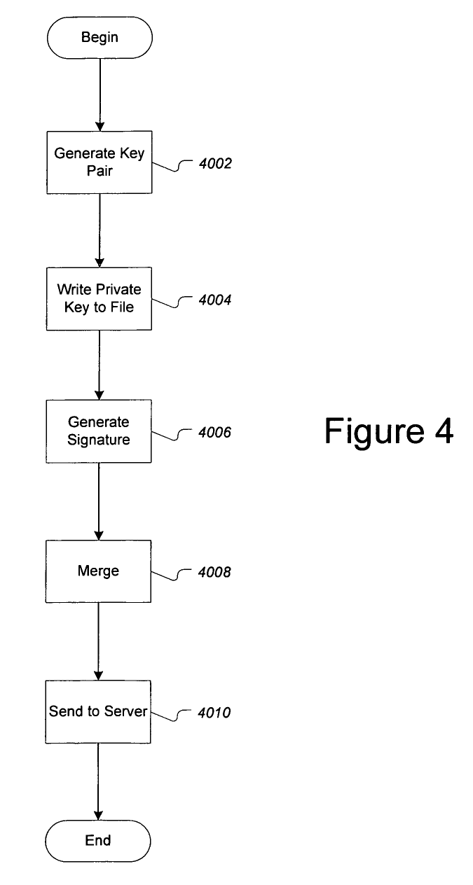

One example of the operation of the second software module is illustrated in the FIG. 4 as a flow diagram. The first module generates a key pair, e.g., a 1024-bit RSA key pair, and a session key, e.g., a 256-bit AES random session key to protect the private key just generated (4002). The encrypted private key is stored in a file (4004). For ease of recognition and usage, the private key file may follow a naming convention that includes the Numerical Id with which it is associated. On completion of this step, the module proceeds to compute a digital signature of the public key (4006). In one embodiment, the public key is also written to a file that follows a naming convention that includes the Numerical Id with which the public key is associated. This is being done to ensure that there would be no man-in-the-middle sort of foul play during the registration process. Next, merging (4008) of the public key, public key length, signature length, public key signature, and activation password takes place. The resultant string is held in the memory module of the computing system. This string can also include additional header information including optionally a code to identify the function requested by the computing system from the public encryption key server, the application id of the first software module, the major version number of the second software module, the minor version of the second software module, the application id of any other software module that may be added as an upgrade to the current system, the module's major version, and the said module's minor version. Once the public key is thus prepared for registration, the second module takes over to communicate with the public encryption key server (1018). These operations can be implemented using methods known to those having ordinary skill in the art.

In one embodiment, the second module sends a request to the public encryption key server (1018) with a string for registration. On reception of the response string from the public encryption key server, which contains the Numerical Id and the public key, both digitally signed using the private key of the public encryption key server, the second module verifies the digital signature by performing a decryption operation using the public encryption key server's public key. If the signature is verified, then the public key of the user is compared with the public key already written to the file. On reception of the request from the computing system by the public encryption key server, the module preprocesses the request to check the identification code of the string to determine the function to be performed. If the code indicates that the function to be performed is public key registration, then the signature of the public key is first extracted and verified using the public key. The public key is then checked for redundancy in a third database 21b which contains all public keys registered thus far with the public encryption key server. If there is a redundancy, then an error is returned to the computing system which initiated the conversation for a regeneration of key pair. Otherwise, a Numerical Id is generated to represent the public key. This Numerical id is generated in sequence starting from a particular number. For ease of management, there can be more than one starting number to represent different groups of Numerical Ids. Thus the generated Numerical Id can be an increment from the last Numerical ID allotted in any of the groups. After this, a directory processing module registers the key pair by adding it to the directory which is also the third database, along with details like the Numerical Id. This done, a response string, is sent back to the computing system and specifically to the software module. These operations can be implemented using methods known to those having ordinary skill in the art.

In one embodiment, the user is notified of the registration of his public key and the allotment of a Numerical Id. Similar registration processes are performed for other participants if they want to make use of the secure public server and the Numerical Id model for the purpose of performing cryptographic operations to transform an encrypted message to the unencrypted form.

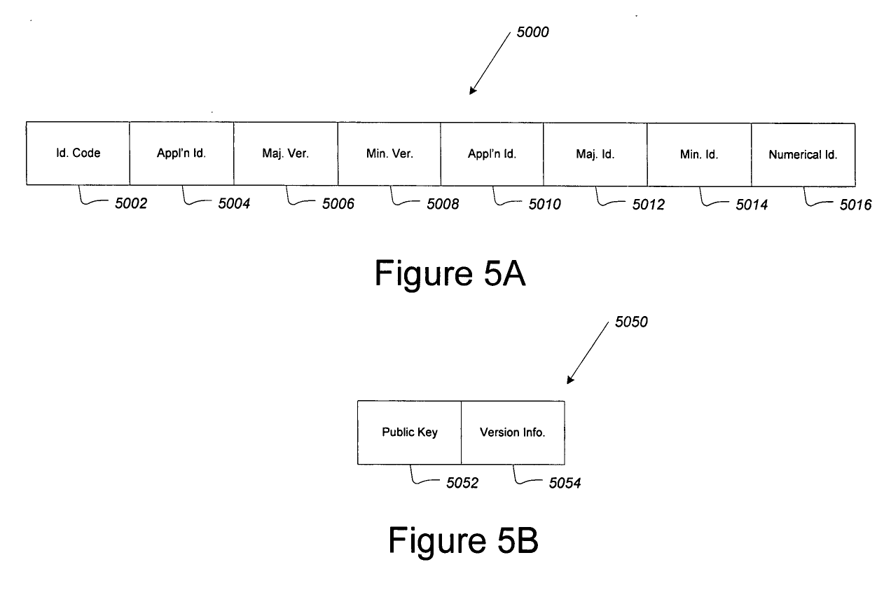

Once the public key is registered with the key distribution server, the server can respond to public key requests from any legitimate module when the module requires a public key corresponding to the Numerical Id for the purpose of encryption. One request format is illustrated in FIG. 5A as a string (5000). The request format consists of an identification code (5002) that specifies that this is a request for public key. It then contains the application id (5004) of the software module, the module's major version number (5006) and minor version (5008). Additionally, this string also contains the application id (5010) of any module that is added to as an upgrade to the invention, its corresponding major version (5012) and minor version (5014). The string (5000) additionally contains the Numerical Id (5016) for which public key is requested from the server. The response string (5050) shown in FIG. 5B from the server consists of the public key (5052) corresponding to the Numerical Id (5054). On reception of the public key, the software module can make use of the same for any cryptographic operations needed.

It is not uncommon for key pair owners to lose their private keys. Also, private keys can get compromised on many occasions. Under such conditions, the owner of the key pair should be able to cancel his keys. Thus, in one embodiment of the invention, assuming that the user has compromised his private key, he will be able to indicate it to the Web server. In a more specific embodiment, the user enters his Numerical Id in the appropriate text box and submits the form to Web server. The Web server passes the Numerical Id as a parameter to the public encryption key server using appropriate server side scripts indicating that the user would like to cancel his key pair. The public encryption key server then generates a confirmation password and sends this password to the user to his email id along with a link to a confirmation Web page. The user enters the confirmation password, and the web server retrieves this password using appropriate server side scripts and passes it to the public encryption key server. The public encryption key server compares this password with the confirmation password it originally generated and if they match, the public key is marked as cancelled from the third database. This ensures that future requests for the public key are not serviced.

In still another embodiment, users other than the owner of the system (i.e., the primary user) may need to protect their files in a situation where the computer system is a shared one. Under such circumstances, in some embodiments, the present invention allows the users to register as alternative primary users. This also encourages users to follow secure practices during usage of their computer systems.

In another embodiment, to ensure the proper functioning of the invention and for the purpose of preventing any mishaps from using outdated modules of the invention, the invention makes use of suitable version numbers. In the event of there being a connection to the Internet, the encryption module may contact a server for making queries with regard to checking the usability status of the invention.

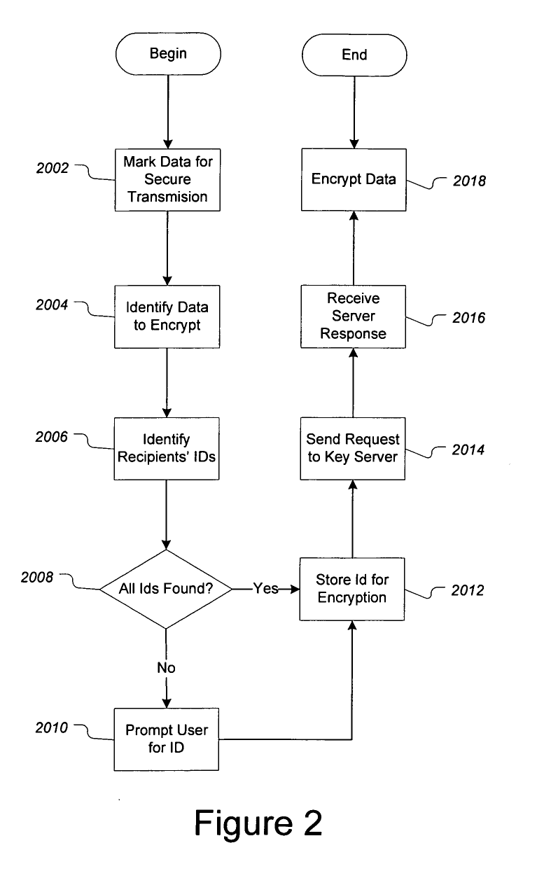

One example of a process for encrypting data in accordance with one embodiment of the invention is provided below and illustrated in FIG. 2. First, the user identifies data to be transmitted securely (2002). For example, the user shares a folder and sets the appropriate access permissions provided by the application or prepares an e-mail for secure transmission. The user then identifies the data to be encrypted (2004). The user is then prompted to provide the identifiers (e.g., e-mail addresses) of the persons who should be authorized to access the secure data (2006). This prompting may occur through a graphical user interface or through the command line itself depending on the environment in which the user is working. The encryption software module then scans the friendly identifiers provided by the user and attempts to find the corresponding Numerical Ids from the profile of the user (2008). If the system cannot locate the corresponding numerical ids of the authorized users, the module prompts the user to provide the same (2010). If the user is unable to provide the information requested by the module, the user indicates so with the click of an appropriate button or typing a specific command in the case of command line interface. Alternatively, other mechanisms for locating Numerical Ids can be provided as will be appreciated by those having ordinary skill in the art. If the encryption software module is unable to obtain the Numerical ids of all the persons who were chosen to be authorized for access to the files, then it encrypts the files for only the owner of the files and exits (2012). These operations can be implemented by those having ordinary skill in the art.

The encryption module sends a request to a public key distribution server with the Numerical Ids of the list of persons who are authorized to access the files (2014). On receipt of response from the public key distribution server, the encryption module proceeds to actually encrypting the files inside the chosen folder (2016). The content of the file is initially encrypted, e.g., using the AES session key generated at random. The encrypted message can be further encoded in base-64 format if the encoded text is to be transmitted as ASCII characters. The encryption module then proceeds to encrypt the key generated (2018) with each of the public keys and embeds them into the header of the encrypted message. When the encryption is complete, the user is indicated of the same through an appropriate message. All files that were encrypted can be provided with a unique extension and icon to identify the encrypted data more clearly. These operations can be implemented by those having ordinary skill in the art.

In one embodiment, the invention can be used to decrypt shared folders, such as used in peer-to-peer data sharing networks, using a process similar to that just described in FIG. 2. For example, a user accesses the shared folder over the network, and chooses one or more files for decryption. Next, the user invokes the decryption module of the invention, e.g., by either clicking an appropriate menu item or by using suitable commands. On retrieving the successful password, the invention proceeds to decrypt the encrypted session key for that Numerical Id. Once the plain text session key is obtained, it is used to decrypt the encrypted message itself. These operations are repeated for each chosen file. Once the decryption is complete, the decrypted files will lose their unique extensions and have their original icons and extensions. These operations can be implemented by those having ordinary skill in the art.

### 7 CONCLUSION

The invention thus allows average users to share files securely in a compute network. The invention does not require any change to the existing applications nor in the mechanism of sharing files. With Internet applications and especially search engines getting more and more sophisticated, the invention is timely and appropriate for protection of shared files. Although specific embodiments and examples have been described herein for the purpose of describing the invention, those having ordinary skill in the art will understand that many alternative embodiments can be implemented without depart from the scope or spirit of the invention.

What is claimed:

1. A system for secure data transmission, comprising:
a encryption key server configured to provide a encryption key in response to a request from a client computer, said encryption key server being further configured to provide an identifier that is associated uniquely with said encryption key.

2. The system of claim 1, wherein said encryption key is the public key of a key pair consisting of a public key and a private key.

3. The system of claim 2, wherein said identifier is associated uniquely with said public key.

4. The system of claim 1, wherein said encryption key server further includes a database of identifiers.

5. The system of claim 1, wherein said identifier is also associated with an e-mail address.

6. The system of claim 1, wherein said client computer is configured to encrypt data sent from said client computer to a receiver computer.

7. The system of claim 6, wherein said client computer is configured to send an identifier associated uniquely with a user of said receiver computer.

8. The system of claim 7, wherein said client computer is configured to receive a public key associated uniquely with a user of said receiver computer

9. The system of claim 8, wherein client computer is configured to encrypt said data sent from said client computer to said receiver computer.

10. The system of claim 9, wherein said data comprises a header including the public key of the user of said client computer.

11. The system of claim 10, wherein said receiver computer is configured to receive and decrypt said encrypted data.

12. The system of claim 8, wherein said data comprises e-mail, VOIP, a data file, image data, or sound data.

13. A method for encrypting data, comprising:
sending a request for an encryption key and unique identifier associated with said encryption to a encryption key server, said encryption key server being configured to provide said encryption key in response to said request, and said encryption key server being further configured to provide an identifier that is associated uniquely with said encryption key.

14. The method of claim 13, further comprising comparing said unique identifier against a database of identifiers.

15. The method of claim 14, further comprising associating said identifier with a public key of a public-private encryption key pair.

16. The method of claim 15, further comprising sending an identifier for a receiver to said encryption key server.

17. The method of claim 16, further comprising receiving a public key for said receiver.

18. The method of claim 17, further comprising encrypting data sent from a user to said receiver using said public key for said receiver.

19. The method of claim 18, wherein said encrypting includes providing a header including the public key for said user.

20. The method of claim 19, further comprising decrypting data sent from a user to said receiver using said public key for said receiver.
